(19) United States
(12) Patent Application Publication
(10) Pub. No.: US 2024/0327559 A1
(43) Pub. Date: Oct. 3, 2024

(54) PMMA RESIN WITH IMPROVED SCRATCH RESISTANCE AND IMPACT RESISTANCE AND PREPARATION METHOD THEREOF

(71) Applicant: GWANGJU INSTITUTE OF SCIENCE AND TECHNOLOGY, Gwangju (KR)

(72) Inventors: Ji-woong PARK, Gwangju (KR); Jun-sik NAM, Gwangju (KR)

(21) Appl. No.: 18/603,190

(22) Filed: Mar. 12, 2024

(30) Foreign Application Priority Data
Mar. 31, 2023 (KR) 10-2023-0042825
Jul. 12, 2023 (KR) 10-2023-0090500

(51) Int. Cl. C08F 265/04; C08F 8/32; C08J 3/24; C08K 5/16

(52) U.S. Cl. CPC C08F 265/04; C08F 8/32; C08J 3/247; C08K 5/16; C08F 2400/02; C08F 2810/20; C08J 2333/12

(57) ABSTRACT

The present inventive concept relates to a PMMA resin that has improved impact resistance and scratch resistance at the same time, while maintaining excellent optical properties of conventional PMMA resins, and a preparation method thereof. More specifically, the present inventive concept relates to a crosslinked PMMA resin comprising PMMA chains crosslinked among each other and polyamine as a crosslinking agent, wherein the polyamine is coupled between the PMMA chains to yield the crosslinked PMMA resins, wherein the polyamine is selected from the group consisting of diamine, triamine and tetramine that have a C₂-C₅₀ linear, branched or cyclic group.

### CROSS-REFERENCE TO RELATED PATENT APPLICATION

This application claims the benefit of Korean Patent Application No. 10-2023-0042825, filed on Mar. 31, 2023, and Korean Patent Application No. 10-2023-0090500, filed on Jul. 12, 2023, in the Korean Intellectual Property Office, the disclosure of which is incorporated herein in its entirety by reference.

### BACKGROUND OF THE INVENTIVE CONCEPT

### 1. Field of the Inventive Concept

The present inventive concept relates to a PMMA resin that has improved impact resistance and scratch resistance at the same time, while maintaining excellent optical properties of conventional PMMA resins, and a preparation method thereof.

### 2. Description of the Related Art

A display device includes a display panel with a plurality of pixels for displaying an image and a cover window formed on the display panel to protect the display panel from external shocks or contamination. The cover window requires high hardness properties to prevent surface scratches, high strength properties to prevent damage from external impacts, and excellent optical properties to prevent damage or distortion of images displayed on the display panel. Moreover, as the application fields of display devices become more diverse, moving away from flat structures, there is also a demand for curved surface processing capability to facilitate processing into various shapes. For example, displays applied to automobiles are evolving beyond conventional simple rectangular navigation systems, and display products with a center information display (CID) implemented in the entire front are released or expected to be released. Accordingly, moving away from flat structures, there is a demand for cover windows that can freely form various shapes and curved surfaces, allowing for large-area integration.

Tempered glass, which has been primarily used for conventional cover windows, has the advantages of being resistant to scratches due to its high-strength properties and having excellent optical properties. However, tempered glass is relatively heavy, making it difficult to apply to lightweight displays such as portable devices or eco-friendly vehicles. Moreover, it is prone to impact damage and is scattered by the impact, potentially causing secondary damage. Furthermore, it does not meet the recent demands in the display market for curved or differently shaped processing.

Recently, extensive research has been conducted to implement the cover windows with plastic materials to address the problems of tempered glass. Examples of plastic materials used for the cover windows include polycarbonate (PC) and polymethylmethacrylate (PMMA), and colorless polyimide (CPI) has attracted attention as a material for cover windows for flexible displays. Plastic materials are promising as alternatives to glass due to their lightweight, impact resistance, transparency, and flexibility; however, they have not fully replaced glass yet, as their physical properties such as impact resistance, scratch resistance, etc., and optical properties including light transmittance are still not sufficient.

The development direction to overcome these drawbacks can be broadly divided into two main approaches. The first is to improve the physical properties by forming various functional layers on the surface of plastic substrates. Typical examples of these functional layers include hard coating layers to improve scratch resistance or impact resistance, anti-reflective layers and/or anti-glare layers and anti-fouling layers to improve optical properties. However, since there are conflicting properties among the properties required for the cover windows, making it difficult to satisfy all properties simultaneously with a single functional layer. As an example, achieving high hardness properties by means of a hard coating may compromise processability, leading to the occurrence of cracks or reduced impact resistance during curved surface processing. Imparting flexibility to the hard coating layer to improve processability may lead to a decrease in hardness, along with reduced optical properties. Therefore, it is common to form a multilayered structure to satisfy various properties. However, as the number of layers in the cover window increases, the manufacturing process becomes more complex, leading to higher production costs. Moreover, concerns arise about potential degradation in optical properties due to reflection or refraction at the interfaces between layers, as well as degradation in durability due to delamination between layers. Furthermore, if the fundamental properties of the plastic substrate are not favorable, there may be inherent limitations to improving the properties by means of the functional layers.

Based on the recognition of these problems, the second development direction involves designing the plastic substrate itself to meet the required properties for the cover window. This approach allows for minimizing the number of stacked functional layers, and further, it enables the formation of the cover window using unpainted resin, where no functional layers are formed.

CPI is a relatively expensive material, so apart from flexible displays, PMMA and PC are mainly employed as plastic cover window materials. PC, with a light transmittance of around 90%, is colorless and transparent, and it is used in place of sheet glass due to its excellent heat resistance and impact resistance. However, PC is vulnerable to scratches and abrasion, has low chemical resistance to organic solvents such as acetone, turns yellow over prolonged exposure to sunlight or ultraviolet radiation, and is more costly than PMMA. PMMA has an outstanding transparency with light transmittance of about 92%. It exhibits excellent scratch resistance and relatively strong chemical resistance. However, it has a drawback of low impact strength, making it more prone to fracture upon external impact. Despite its pencil hardness from H to 2 H, which is higher than that of PC, further improvement in hardness is necessary for applications such as touchscreens.

To this end, there have been attempts to address the drawbacks of PC and PMMA by coextruding PC/PMMA, or improve the properties of PMMA by adding impact modifiers, producing copolymers, or blending polymers. However, in the case of coextruded resins containing two materials with different properties, resins with added impact modifiers, or resins with blended polymers, there will be problems such as a decrease in physical properties due to poor interfacial adhesion between different materials, a degradation in optical properties due to differences in properties such as heat resistance and refractive index, and a reduction in durability such as interfacial cracks or warping. Furthermore, impact modifiers, which are made up of fine rubber or inorganic particles, can cause problems due to particle agglomeration. PMMA copolymers, being chemically bonded to polymers derived from other monomers, can form a more stable structure compared to the aforementioned methods. However, there are still problems such as the formation of phase-separated domains due to the low compatibility between different chemical unit structures and the weakening of the basic properties of PMMA, as is common in typical copolymers. In addition, methods involving crosslinking of PMMA or its copolymers in their solutions encounter difficulties in achieving uniform reaction between different polymer chains and in processing the resin after the solution-crosslinking. In the known crosslinking method that uses a Lewis acid catalyst in a molten state, it is hard to remove the catalyst completely from the cross-linked resin, and the residual catalyst may affect the physical properties and/or durability of the polymer.

### REFERENCES OF THE RELATED ART

### Patent Documents

Patent Document 1: Korean Patent No.: 10-1219140

Patent Document 2: Korean Patent No.: 10-1584447

Patent Document 3: Japanese Patent No.: 5950532

### Non-Patent Documents

Non-Patent Document 1: Polymer Journal (2012) 44, 301-305.

### SUMMARY OF THE INVENTIVE CONCEPT

The present inventive concept has been made in an effort to solve the above-described problems associated with prior art, and an object of the present inventive concept is to provide a new PMMA resin that has improved to exhibit enhanced impact resistance and scratch resistance at the same time, while possessing excellent optical properties of the conventional PMMA resins, and a preparation method thereof.

Another object of the present inventive concept is to provide a transparent substrate comprising the PMMA resin with excellent impact resistance, scratch resistance, and optical properties.

Still another object of the present inventive concept is to provide a cover window for a display device using the transparent substrate.

The objects of the present inventive concept are not limited to those mentioned above, and other objects not mentioned will be clearly understood by those skilled in the art to which the present inventive concept pertains. Moreover, in the following description, if detailed descriptions of well-known techniques would unnecessarily obscure the gist of the present disclosure, the detailed descriptions will be omitted.

In order to achieve the above-mentioned objects, the present inventive concept provides a crosslinked PMMA resin comprising PMMA chains crosslinked among each other and polyamine as a crosslinking agent, wherein the polyamine is coupled between the PMMA chains to yield cross-linked PMMA resins, wherein the polyamine is selected from the group consisting of diamine, triamine and tetramine that have a C₂-C₅₀ linear, branched or cyclic group.

As used herein, the term “PMMA” collectively refers to the polymers with methacrylic groups as a repeating unit, and examples thereof may include at least one polymer selected from the group consisting of methyl methacrylate, ethyl methacrylate, propyl methacrylate, butyl methacrylate, phenyl methacrylate, and benzyl methacrylate. The PMMA chains may be composed of a single monomer or may be a copolymer of two or more comonomers. Even in the case of a copolymer, the basic repeating units are similar, ensuring high compatibility, and thus this copolymer does not cause the problems of copolymers of monomers with completely different properties.

According to the present inventive concept, the PMMA chains may be crosslinked with polyamine as a crosslinking agent selected from the group consisting of diamine, triamine and tetramine that have a C₂-C₅₀ linear, branched or cyclic group, which are low-molecular weight substances. Due to the presence of ester functional groups in the chains of the PMMA, it can react with amines to form amide bonds. Therefore, when reacting with low-molecular weight polyamines, a crosslinked PMMA resin is formed, either within a polymer chain or between different PMMA chains. FIG. 1 is a schematic diagram illustrating the concept of the crosslinked PMMA resin of the present inventive concept. With the introduction of crosslinking in the PMMA resin of the present inventive concept, the crosslinked PMMA resin maintains excellent optical properties along with significantly increased impact resistance and scratch resistance (pencil hardness). In general, the impact resistance and scratch resistance are known to have a trade-off relationship where, as one property increases, the other decreases. However, in the resin of the present inventive concept, it was possible to enhance both impact resistance and scratch resistance simultaneously.

The above-mentioned crosslinking agent, polyamines may contain elements other than carbon and nitrogen within the structure. The polyamine is a C₂-C₅₀ linear, branched or cyclic polyamine. The cyclic polyamines may contain aliphatic or aromatic rings. Moreover, the linear, branched, or cyclic polyamine may also contain a double bond in its structure. In the case where the polyamine contains two or more aromatic rings, and/or contains a double bond that does not constitute two or more aromatic rings, and/or contains an aromatic ring and a double bond that does not constitute an aromatic ring, the polyamine may preferably have a structure where the aromatic ring and the double bond are not conjugated to each other. In the present inventive concept, the crosslinking agent is used in small amounts, and thus it has little effect on the overall color of the resin. However, if aromatic rings and/or double bonds are conjugated to each other, the optical properties of the resin may be deteriorated. The cyclic group may be a cycloalkyl group composed of a single ring, a bicyclo-alkyl group containing two or more rings, a spiro-alkyl group, or an aromatic ring. If the number of carbons constituting in the crosslinking agent is too high, the degree of freedom of the chains in the crosslinking agent may be too high, potentially leading to a decrease in the properties strengthened by crosslinking. Whereas, if the number of carbons is too low, the length of the crosslinking agent may be too short, making it difficult for crosslinking between polymer chains, and thus a C₆-C₁₂ linear, branched or cyclic polyamine is more preferred. Examples of the linear crosslinking agent may include 1,4-diaminobutane, 1,6-diaminohexane, 1,8-diaminooctane, 1,10-diaminodecane, 1,12-diaminododecane, 1,20-diaminoundecane, tris (2-aminoethyl) amine, tris (3-aminopropyl) amine, and tetrakis (3-aminopropyl) amine; examples of the branched crosslinking agent may include 1,3-diaminobutane, 1,4-diaminohexane, 1,6-diaminooctane, 1,10-diaminodecane, and 1,12-diaminododecane; and examples of the cyclic group may include 1,3-diaminocyclohexane, 1,4-diaminocyclohexane, adamantane-1,3-diamine, adamantane-2,6-diamine, bicyclo [2,2,2] octane-1,4-diamine, bis (hexamethylene) triamine, isophorone diamine, tris (4-aminophenyl) amine, diethylene triamine, pentane-1,3,5-trimaine and tetrakis (4-aminophenyl) methane, but are not limited thereto.

In the following Examples, it can be observed that the properties of crosslinking vary depending on the structure of the alkyl group of the crosslinking agent. For example, compared to crosslinking agents comprising a linear alkyl group with a long distance between amine groups and a high degree of freedom, crosslinking agents comprising a cyclic group with a short distance between amine groups and a low degree of freedom yielded a lower proportion of insoluble PMMA after cross-linking the PMMA under the same conditions, indicating that the degree of crosslinking within polymer chains by the longer linear alkyl amine would be higher than that by the shorter cyclic amines. FIG. 2 is a schematic diagram illustrating crosslinking between polymer chains and within polymer chains. Short-chain or cyclic crosslinking agents with fewer carbon atoms have a shorter distance between amine groups, resulting in crosslinking points being closer together and creating a rigid structure that restricts movement. In contrast, long-chain linear crosslinking agents with a more flexible structure will allow for greater flexibility between crosslinking points. Likewise, as the number of amine groups in the crosslinking agent increases, the crosslinked PMMA will have a more rigid structure. The impact resistance is measured as drop impact strength, and the variation in drop impact strength depending on the concentration of crosslinking agent showed two peak values. Crosslinking agents with a rigid structure were effective in improving drop impact strength in lower concentration ranges, while crosslinking agents with a flexible structure were effective in improving drop impact strength in relatively higher concentration ranges.

Therefore, in the crosslinked PMMA resin of the present inventive concept, the crosslinking may be achieved by a single crosslinking agent, but it is more preferable that it is achieved by one or more crosslinking agents. When the PMMA resin is crosslinked by one or more crosslinking agents, the PMMA resin may be preferably crosslinked by a mixture of a crosslinking agent comprising a C₂-C₅₀ linear alkyl group and a crosslinking agent comprising a C₃-C₅₀ cyclic group to obtain the effects of crosslinking of both rigid and flexible structures. By using a mixture of a crosslinking agent with a flexible linear alkyl group and a crosslinking agent with a rigid structure, an enhanced effect can lead to a more efficient improvement in impact resistance and scratch resistance.

In the present inventive concept, the total amount of the crosslinking agent added may be preferably in a molar ratio of 0.01 to 1.0 with respect to the repeating units of the PMMA resin. The present inventive concept is characterized by improved impact resistance and scratch resistance with a small amount of crosslinking agent, without significantly compromising the optical and mechanical properties of PMMA. If the molar ratio is too low, the degree of improvement in scratch resistance or impact resistance will not be sufficient. Moreover, if the molar ratio exceeds 1.0, there is no further improvement in properties, and an excess of crosslinking agent molecules may aggregate or distribute non-uniformly, potentially leading to a degradation in optical properties or other physical properties. The presence of low-molecular weight crosslinking agents, remaining without crosslinking, can potentially compromise the durability of the polymer resin due to bleed out.

The crosslinked PMMA resin may preferably have a weight-average molecular weight in the range of 20,000 to 300,000, more preferably in the range of 150,000 to 250,000. However, the relationship between the molecular weight and the impact resistance or scratch resistance is not necessarily linear, and thus it is not strictly limited to the mentioned ranges.

Another aspect of the present inventive concept relates to a method of preparing a crosslinked PMMA resin, the method comprising mixing a PMMA resin with polyamine as a crosslinking agent and producing the PMMA resins by crosslinking the PMMA chains with polyamines, wherein the polyamine is selected from the group consisting of diamine, triamine and tetramine with a C₂-C₅₀ linear, branched or cyclic group, followed by a crosslinking reaction.

For crosslinking reaction with a solvent, the random coils of the polymer chains can be dispersed, allowing intrachain crosslinking to occur predominantly regardless of the type or concentration of the crosslinking agent. Therefore, it is preferable for the crosslinking reaction to be carried out by a melt process in order to achieve improved physical properties using a minimum amount of crosslinking agent to form a low number of crosslinking points. In a molten state, polymer chains are entangled, and the mechanical properties manifested depending on the degree of entanglement. Adding a very small amount of crosslinking to the entangled chains significantly increases the molecular weight, leading to a significant improvement of mechanical properties. Specifically, the crosslinking reaction of the present inventive concept may be carried out at 100 to 1000 kg/cm² and at temperatures of 140 to 300° C. When increasing the temperature to the above reaction temperature, it is preferable to gradually increase the temperature to first allow the formation of a low number of crosslinking points. For example, during the crosslinking reaction, the temperature can be maintained for a specified period at an intermediate temperature, such as 180° C. to 210° C., as illustrated in the Examples, before raising the temperature to the next level. The stepwise temperature increase, as described above, helps prevent rapid crosslinking and allows for uniform crosslinking to occur across the entire PMMA resin. This approach ensures that the properties of crosslinking are sufficiently exhibited depending on the type of crosslinking agent.

When using two or more types of crosslinking agents, it is preferable to first uniformly mix the crosslinking agents before mixing with the PMMA resin for the crosslinking reaction. If the crosslinking agents are not uniformly mixed, the uneven distribution of the crosslinking agents may affect the crosslinking, which interferes with the preparation of a crosslinked PMMA resin with uniform and reproducible properties.

Still another aspect of the present inventive concept relates to a transparent substrate comprising the crosslinked PMMA resin according to the present inventive concept. In the present inventive concept, the “substrate” is not limited to a rectangular shape and can be manufactured into various molded products of various shapes by methods such as injection molding, extrusion, etc. The transparent substrate comprising the crosslinked PMMA resin of the present inventive concept has significantly improved impact resistance and scratch resistance, which are the drawbacks of conventional PMMA resin-derived transparent substrates, while maintaining excellent optical characteristics. More specifically, the transparent substrate of the present inventive concept exhibits a light transmittance of 90% or more at 550 nm, similar to or even superior to glass. The impact resistance, which is the major drawback of conventional PMMA substrates, has been significantly improved. As a result, the drop impact strength as determined by ASTM D3763-18 increases to 0.1-1.0 J, leading to improved impact resistance, ranging from at least 5 to 50 times, compared to PMMA substrates under the same conditions. Furthermore, the pencil hardness, which serves as a measure of scratch resistance, has also been improved. While conventional PMMA substrates typically have a pencil hardness ranging from H to 2 H, the crosslinked PMMA substrate of the present inventive concept exhibits a pencil hardness of 3 H to 5 H, improving scratch resistance along with impact resistance. The improvement of both properties, previously perceived as a mutual trade-off relationship, can further expand the applicability of the transparent substrate of the present inventive concept. Therefore, the transparent substrate of the present inventive concept can find applications in various fields, including optical fields such as displays, optical recording, optical communication, etc., as well as lighting, various cases, signboards, glass substitutes, eyeglasses, optical lenses, etc.

The transparent substrate of the present inventive concept is particularly suitable for use as a cover window for a display device. While conventional transparent substrates made of PMMA have higher scratch resistance than transparent substrates made of PC, their pencil hardness is not sufficient for use as substrates of cover windows for display devices with frequent contact, such as in touch displays. Thus, the formation of hard coating layers is essential, and impact-resistant layers or materials are also required to compensate for the low impact resistance of PMMA. Moreover, due to the low pencil hardness and impact resistance of the base substrate, there were limitations in relying on the hard coating layers or impact-resistant layers to supplement these properties. In contrast, the transparent substrate of the present inventive concept has significantly improved impact resistance and pencil hardness, and thus has excellent impact resistance and scratch resistance. However, the present inventive concept does not exclude the formation of at least one of the hard coating layer and the impact resistance layer on the transparent substrate of the present inventive concept to further improve the impact resistance and scratch resistance.

As described above, the crosslinked PMMA resin according to the present inventive concept, with a low number of crosslinking points formed by a small amount of crosslinking agent, maintains the excellent optical properties, which are the advantages of the PMMA resin, and has significantly improved impact resistance and scratch resistance, addressing the drawbacks of conventional PMMA resins. Therefore, it can be effectively used in applications such as optical lenses, various windows, signboards, etc., which were difficult to use PMMA resins due to their low impact resistance or which had low durability in use. In particular, it can be beneficially used as a cover window substrate for a display device, which requires excellent optical properties as well as scratch resistance and impact resistance.

### BRIEF DESCRIPTION OF THE DRAWINGS

The above and other features and advantages of the present inventive concept will become more apparent by describing in detail exemplary embodiments thereof with reference to the attached drawings in which:

FIG. 1 is a schematic diagram illustrating the concept of a crosslinked PMMA resin of the present inventive concept;

FIG. 2 is a schematic diagram illustrating the types of crosslinking in a crosslinked PMMA resin;

FIG. 3 shows photographs of crosslinked PMMA substrates prepared using different crosslinking agents;

FIG. 4 shows graphs illustrating the pencil hardness of crosslinked PMMA substrates;

FIG. 5 shows graphs illustrating the drop impact strength of crosslinked PMMA substrates;

FIG. 6 shows a graph illustrating the drop impact strength of a crosslinked PMMA substrate according to another Example;

FIG. 7 shows graphs illustrating the pencil hardness of crosslinked PMMA substrates using mixed crosslinking agents; and

FIG. 8 shows graphs illustrating the drop impact strength of crosslinked PMMA substrates using mixed crosslinking agents.

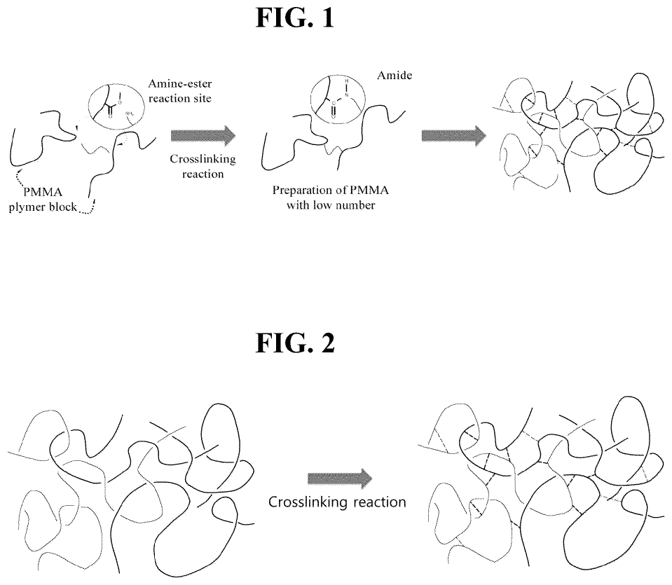

### DETAILED DESCRIPTION OF THE INVENTIVE CONCEPT

Hereinafter, the present inventive concept will be described in more detail with reference to the following examples. However, these examples are merely illustrative for the purpose of describing the scope of the technical idea of the present inventive concept, and the technical scope of the present inventive concept is not limited or changed thereby. It will be understood by those skilled in the art that various modifications and changes are possible within the scope of the technical idea of the present inventive concept based on these examples.

### EXAMPLES

### Example 1: Preparation of Crosslinked PMMA Resins

PMMA (polymethylmethacrylate) was purchased in the form of pellets (HP202) from LXMMA and used after drying at 100° C. under vacuum for 24 hours.

The crosslinking agents used were 1,12-diaminododecane (98%, Sigma-Aldrich), 1,6-hexanediamine (98%, Sigma-Aldrich), adamantane-1,3-diamine (98%, TCI), or trans-1,4-cyclohexanediamine (98%, TCI), which were selected and used without additional purification after purchase. The liquid crosslinking agents were used without any additional treatment, and the solid crosslinking agents were used after being crushed with a mortar and pestle. In the following description and figures, the crosslinking agents will be abbreviated as DOD, HEX, ADA, and CYC.

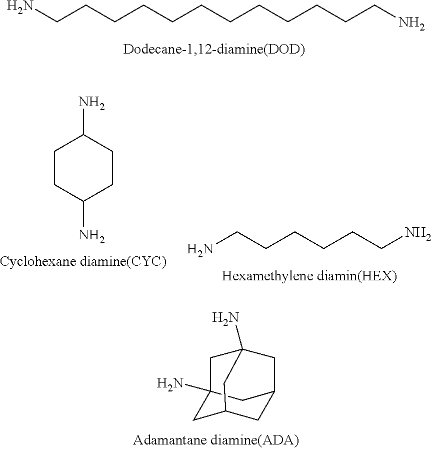 [SMILES: NCCCCCCCCCCCCN ; NC1CCC(N)CC1 ; NCCCCCCN ; NC12CC3CC(C1)CC(N)(C3)C2]

PMMA pellets were mixed with crosslinking agents at molar percentages of 0.033, 0.05, 0.1, 0.2, 0.4, and 0.8 with respect to the repeating units of PMMA and then mixed for 1 minute with a vortex mixer. The mixtures of crosslinking agents and PMMA were then subjected to a stepwise temperature increase using a hot press under a pressure of 800 kg/cm², with reactions carried out at 180° C. for 10 minutes, 190° C. for 10 minutes, 200° C. for 10 minutes, and 210° C. for 20 minutes. The mixtures were then cooled below the glass transition temperature of PMMA while maintaining pressure.

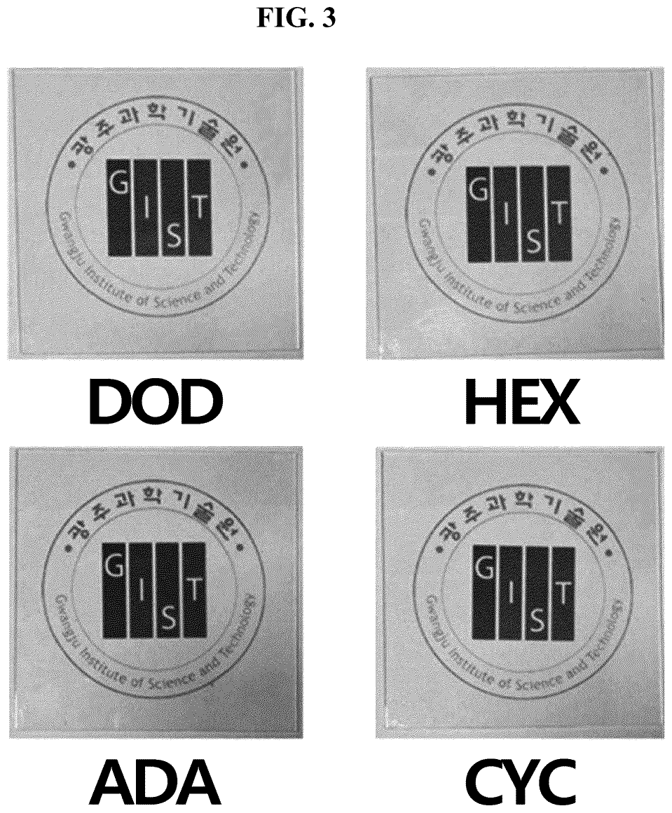

The substrates sized 1 mm×10 cm×10 cm were molded by the hot press method. FIG. 3 shows photographs of the substrates, prepared using 1,12-diaminododecane, 1,6-hexanediamine, adamantane-1,3-diamine, and trans-1,4-cyclohexanediamine as crosslinking agents at a ratio of 0.05 mol % in order from the left to right. In the following description and figures, the crosslinking agents will be abbreviated as DOD, HEX, ADA, and CYC.

### Example 2: Evaluation of Crosslinked PMMA Resin Properties

Using the substrates prepared in Example 1, various properties were evaluated. The properties of PMMA (as prep) prepared by processing PMMA pellets under the same conditions as in Example 1 without adding a crosslinking agent and commercial PMMA (reference) were evaluated and shown in the following Table 1. The light transmittance data for PMMA (reference) in Table 1 were provided by LXMMA, the manufacturer of the pellets.

### 1) Light Transmittance

For the prepared substrates, the light transmittance at 550 nm was measured using a UV-Vis spectrophotometer (Mega-800), and the results are presented in Table 1. In Table 1, the transmittance of the control PMMA is approximately 92%, and the transmittance of the crosslinked PMMA ranges from 91.2% to 92.5%, indicating that the addition of crosslinking agents has little impact on the transmittance of PMMA.

TABLE 1

| | Crosslinking | Transmittance | | Crosslinking | Transmittance |
|---|---|---|---|---|---|
| Samples | agents (mol %) | (%) | Samples | agents (mol %) | (%) |
| PMMA | — | 92.0 | PMMA | — | 92.2 |
| (reference) | | | (as prep) | | |
| PMMA-HEX | 0.8 | 92.1 | PMMA-ADA | 0.8 | 91.5 |
| | 0.4 | 91.4 | | 0.4 | 91.2 |
| | 0.2 | 91.4 | | 0.2 | 91.5 |
| | 0.1 | 92.1 | | 0.1 | 92.0 |
| | 0.05 | 91.2 | | 0.05 | 92.1 |
| | 0.033 | 91.7 | | 0.033 | 92.5 |
| PMMA-CYC | 0.8 | 91.8 | PMMA-DOD | 0.8 | 92.1 |
| | 0.4 | 91.7 | | 0.4 | 91.9 |
| | 0.2 | 91.2 | | 0.2 | 91.2 |
| | 0.1 | 91.9 | | 0.1 | 91.6 |
| | 0.05 | 91.3 | | 0.05 | 91.5 |
| | 0.033 | 91.5 | | 0.033 | 91.2 |

### 2) Pencil Hardness

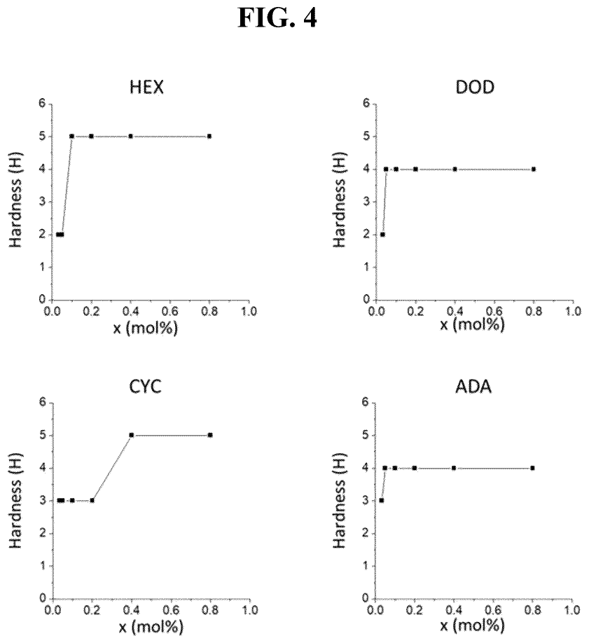

The pencil hardness was measured using an H501 pencil hardness tester (Elcometer), and the results are presented in FIG. 4. The pencil hardness of PMMA ranged from H to 2 H, while the pencil hardness of crosslinked PMMA increased with the increasing amount of the crosslinking agent added. Once a certain pencil hardness level was reached, further increasing the amount of the crosslinking agent added did not significantly change the pencil hardness, maintaining it at a constant value. The highest pencil hardness varied depending on the type of crosslinking agent, with HEX and CYC reaching the highest value of 5 H, while DOD and ADA reaching the highest value of 4 H. For DOD and ADA, the highest pencil hardness of 4 H was achieved with a mole percent of 0.05%. However, for HEX and CYC with the highest pencil hardness of 5 H, the pencil hardness at 0.05% addition was <2 H and <3 H, respectively, showing lower pencil hardness compared to the same amount of DOD or ADA.

### 3) Drop Impact Strength

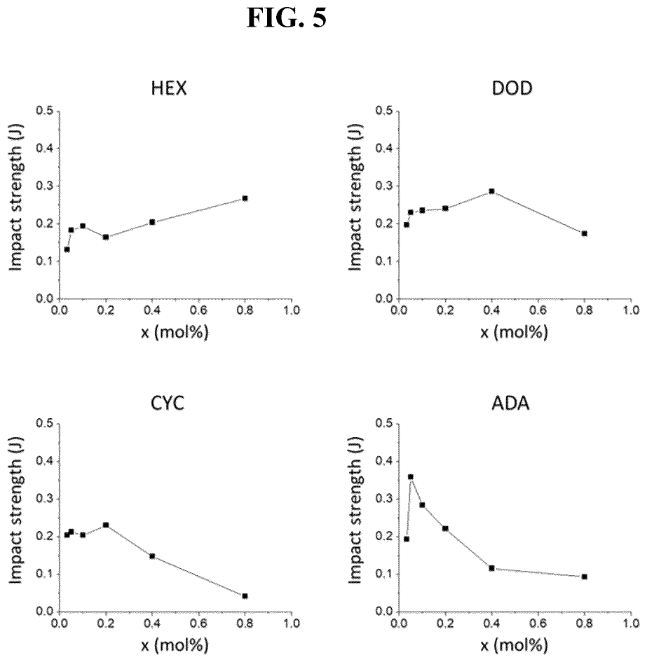

The drop impact strength was measured using a drop impact tester (Instron 9400) according to the ASTM D3763-18 method. A 10 kg weight was dropped with an initial energy of 54 J and an initial drop velocity of 3.21 m/s to destructively test the samples in a circular manner. FIG. 5 shows graphs illustrating the results, where the drop impact strength of PMMA is approximately 0.021 to 0.025 J, indicating a low strength. However, crosslinked PMMA which is the introduction of crosslinking by the addition of crosslinking agents significantly increased the impact strength, reaching a maximum of 0.36 J. Additionally, with an increase in the concentration of the crosslinking agent, the drop impact strength exhibited a graph with two distinct peak values. All four crosslinking agents showed their peak values at concentrations ranging from 0.05 to 0.1 mol %, with ADA exhibiting the highest impact strength. While the first peak value is observed at a low crosslinking agent concentration and the concentration exhibiting the peak value is not significantly affected by the type of crosslinking agent, the concentration at which the second peak value is observed is significantly influenced by the type of crosslinking agent, suggesting that at least two factors will impact the improvement in drop impact strength.

### 4) Measurement of Insoluble PMMA Proportion, Molecular Weight, and Glass Transition Temperature

To determine the properties of the crosslinked PMMA prepared by crosslinking, the molecular weight, the amount of insoluble part of the cross-linked PMMA, and the glass transition temperature were measured and summarized in Table 2 along with the measured pencil hardness and drop impact strength. The weight-average molecular weight of the soluble part was measured by dissolving the crosslinked PMMA in THF and using GPC. The proportion of insoluble PMMA was determined by filtering out the part of the crosslinked PMMA that was not dissolved in THF at a high temperature for one day and then drying it. The glass transition temperature was measured using DSC (TA Instrument, DSC 250).

TABLE 2

| | Crosslinking | Proportion of | | | | |
|---|---|---|---|---|---|---|
| | agents | Insoluble | Pencil | Drop impact | | |
| Materials | (mol %) | parts (wt %) | hardness | strength (J) | M2 (Da) | Tg (° C.) |
| PMMA | — | — | H-2H | 0.02 | — | — |
| (reference) | | | | | | |
| PMMA | — | — | <2H | 0.02 | 134000 | 114.2 |
| (as prep) | | | | | | |
| PMMA-HEX | 0.8 | 67.7 | <5H | 0.26 | — | — |
| | 0.4 | 30.7 | <5H | 0.20 | — | — |
| | 0.2 | 24.0 | <4H | 0.16 | 225000 | 114.3 |
| | 0.1 | 12.9 | <5H | 0.19 | 168000 | 114.4 |
| | 0.05 | 12.7 | <2H | 0.18 | 160000 | 114.3 |
| | 0.033 | 9.8 | <2H | 0.13 | — | — |
| PMMA-CYC | 0.8 | 18.9 | <5H | 0.04 | — | 114.4 |
| | 0.4 | 17.8 | <5H | 0.14 | — | 114.7 |
| | 0.2 | 1.6 | <3H | 0.23 | 235000 | 113.1 |
| | 0.1 | 0.5 | <3H | 0.20 | 179000 | 114.0 |
| | 0.05 | 0 | <3H | 0.21 | 163000 | 113.4 |
| | 0.033 | 0 | <3H | 0.20 | — | — |
| PMMA-ADA | 0.8 | 20.1 | <4H | 0.09 | — | — |
| | 0.4 | 15.3 | <4H | 0.11 | — | — |
| | 0.2 | 5.2 | <4H | 0.22 | — | — |
| | 0.1 | 3.7 | <4H | 0.28 | — | — |
| | 0.05 | 1.8 | <4H | 0.35 | 195000 | 113.7 |
| | 0.033 | 1.5 | <3H | 0.19 | 194000 | 114.1 |
| PMMA-DOD | 0.8 | 50.9 | <4H | 0.17 | 265000 | 113.1 |
| | 0.4 | 31.1 | <4H | 0.28 | 215000 | 112.7 |
| | 0.2 | 22.7 | <2H | 0.24 | 207000 | 113.7 |
| | 0.1 | 17.0 | <4H | 0.23 | 206000 | 112.9 |
| | 0.05 | 10.9 | <4H | 0.23 | 196000 | 112.7 |
| | 0.033 | 4.3 | <2H | 0.19 | 184000 | 113.3 |

Referring to Table 2, the glass transition temperature of PMMA was 114.2° C., and the glass transition temperature of crosslinked PMMA ranged from 112.74 to 114.70° C., indicating that the introduction of crosslinking did not have a significantly impact.

The molecular weight measurement, limited to the fraction dissolved in THF, does not reflect the degree of crosslinking of the entire substrate. However, it can serve as supplementary evidence demonstrating that the molecular weight may increase due to crosslinking in the crosslinked PMMA of the present inventive concept. As the amount of the crosslinking agent added increased, the molecular weight of crosslinked PMMA also increased. However, there was no direct correlation with the drop impact strength of the substrate, which contains the insoluble crosslinked portion. The proportion of crosslinked PMMA can be measured as the proportion of insoluble PMMA. Compared to the crosslinking agents with linear alkyl chains, such as HEX and DOD, cyclic CYC and ADA had a relatively lower ratio of crosslinked PMMA.

### Example 3: Preparation of Crosslinked PMMA Resin Using a Tetramine as Crosslinking Agent

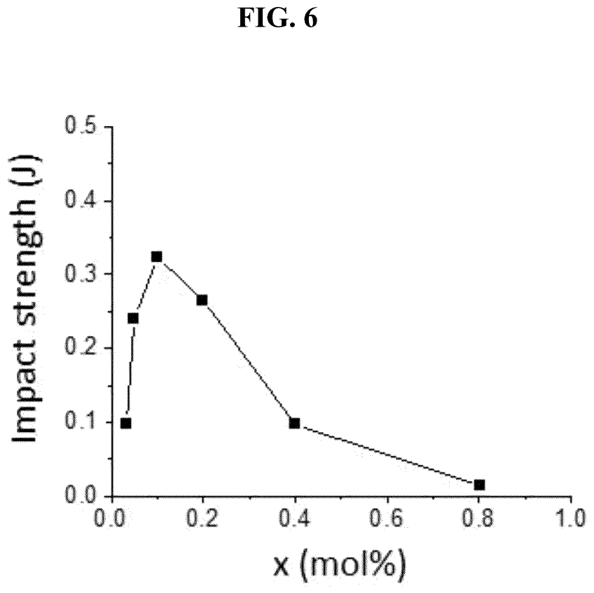

A crosslinked PMMA substrate was prepared in the same manner as in Example 1, except that tetrakis (4-aminophenyl) methane of the following structure was used as a crosslinking agent. The drop impact strength of the prepared substrate was measured by the method described in Example 2, and the results are shown in FIG. 6.

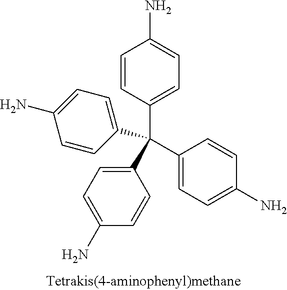

### Example 4: Preparation of Crosslinked PMMA Resins Using Mixed Crosslinking Agents

The proportion of insoluble PMMA in Table 2 and the drop impact strength graph in FIG. 5 suggest that the drop impact strength can increase due to intrachain and interchain crosslinking, and the intrachain and interchain crosslinking can occur preferentially depending on the crosslinking agent. Therefore, the crosslinked PMMA was prepared by mixing the crosslinking agent DOD, which appears to prefer interchain crosslinking, and the crosslinking agent ADA, which appears to prefer intrachain crosslinking.

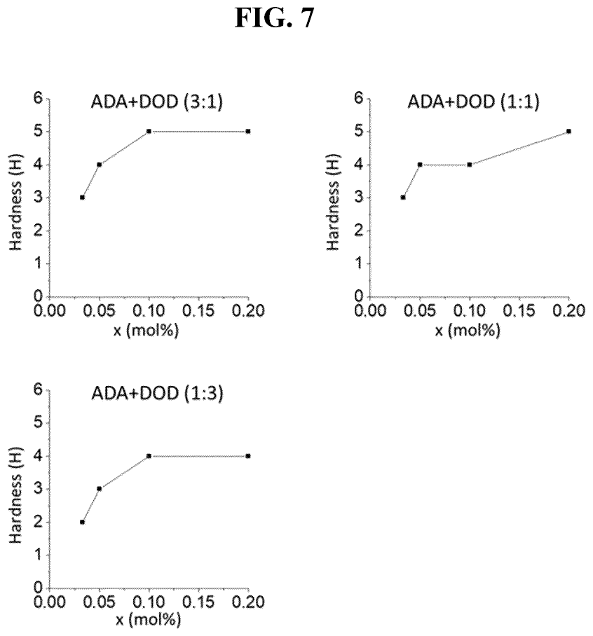

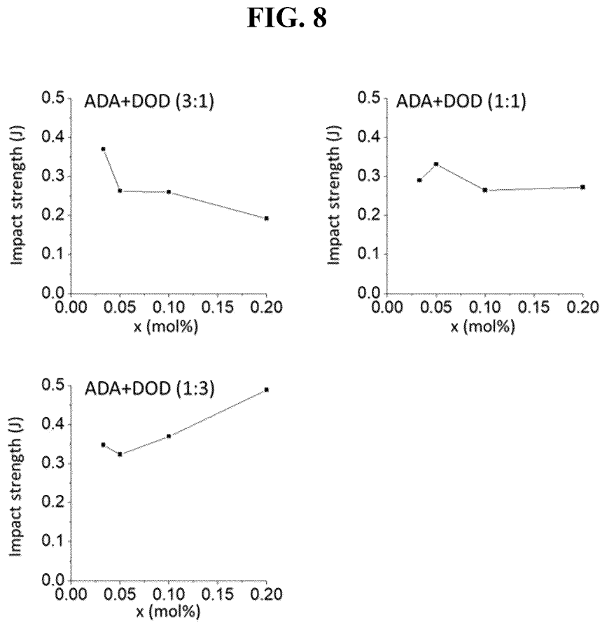

The crosslinked PMMA substrates were prepared in the same manner as in Example 1, except that the mixed crosslinking agents were used instead of a single crosslinking agent. The transmittance, pencil hardness, and drop impact strength were measured in the same manner as in Example 2 using the prepared crosslinked PMMA substrates, and the results are presented in Table 3 and FIGS. 7 and 8.

It can be seen from Table 3 that even when the mixed cross-linking agents were used, the light transmittance remains high, similar to the non-crosslinked PMMA where a single cross-linking agent was used.

TABLE 3

| | Crosslinking | |
|---|---|---|
| Materials | agents (mol %) | Transmittance (%) |
| PMMA (as prep) | — | 92.2 |
| PMMA-ADA-DOD (3:1) | 0.2 | 92.0 |
| | 0.1 | 92.1 |
| | 0.05 | 92.2 |
| | 0.033 | 92.1 |
| PMMA-ADA-DOD (1:1) | 0.2 | 92.2 |
| | 0.1 | 91.9 |
| | 0.05 | 92.1 |
| | 0.033 | 92.2 |
| PMMA-ADA-DOD (1:3) | 0.2 | 92.2 |
| | 0.1 | 92.1 |
| | 0.05 | 92.2 |
| | 0.033 | 92.2 |

FIG. 7 illustrates the pencil hardness of the crosslinked PMMA substrate. As the amount of mixed crosslinking agents added increases, the pencil hardness also increases. Moreover, when a certain value is reached, further increasing the amount of crosslinking agents added beyond this point does not lead to a significant increase in hardness, showing a similar trend to the substrates using a single crosslinking agent. When ADA and DOD were used individually, the maximum pencil hardness was 4 H, but when they were mixed, it reached 5 H when the ratio of ADA: DOD was 3:1 or 1:1. Even with a smaller amount of crosslinking agents, higher pencil hardness values were obtained, showing that there is a synergistic effect due to the use of mixed crosslinking agents.

Similarly, FIG. 8 regarding the drop impact strength also shows a synergistic effect when using mixed crosslinking agents. The drop impact strength increased compared to the PMMA substrates using a single crosslinking agent, and the maximum impact strength value reached 0.48 J. As predicted from the crosslinking agent concentration values showing the peak values in FIG. 5, the use of mixed crosslinking agents with a high DOD ratio resulted in higher drop impact strength.

While the inventive concept has been shown and described with reference to certain preferred embodiments thereof, it will be understood by those skilled in the art that various changes in form and details may be made therein without departing from the spirit and scope of the inventive concept as defined by the appended claims. Therefore, the scope of the inventive concept is defined not by the detailed description of the inventive concept but by the appended claims, and all differences within the scope will be construed as being included in the present inventive concept.

What is claimed is:

1. A crosslinked PMMA resin comprising:
PMMA chains crosslinked among each other; and
polyamine as a crosslinking agent,
wherein the polyamine is coupled between the PMMA chains to yield crosslinked PMMA resins,
wherein the polyamine is selected from the group consisting of diamine, triamine and tetramine that have a C₂-C₅₀ linear, branched or cyclic group.

2. The crosslinked PMMA resin of claim 1, wherein the PMMA comprises at least one polymer selected from the group consisting of methyl methacrylate, ethyl methacrylate, propyl methacrylate, butyl methacrylate, phenyl methacrylate, and benzyl methacrylate.

3. The crosslinked PMMA resin of claim 1, wherein the crosslinking agent is a mixture of two or more crosslinking agents.

4. The crosslinked PMMA resin of claim 3, wherein the crosslinking agent is a mixture of a crosslinking agent comprising a C₂-C₅₀ linear alkyl group and a crosslinking agent comprising a C₃-C₅₀ cyclic group.

5. The crosslinked PMMA resin of claim 1, wherein the PMMA is crosslinked with a crosslinking agent in a molar ratio of 0.01 to 1.0 with respect to the repeating units of the PMMA resin.

6. The crosslinked PMMA resin of claim 1, wherein the crosslinked PMMA resin has a weight-average molecular weight in the range of 20,000 to 300,000.

7. A method of preparing a crosslinked PMMA resin comprising:
mixing a PMMA resin with polyamine as a crosslinking agent; and
producing the PMMA resins by crosslinking the PMMA chains with polyamines,
wherein the polyamine is selected from the group consisting of diamine, triamine and tetramine that have a C₂-C₅₀ linear, branched or cyclic group.

8. The method of preparing a crosslinked PMMA resin of claim 7, wherein the crosslinking reaction is carried out at 100 kg/cm² to 1000 kg/cm² and at temperatures of 140° C. to 300° C.

9. The method of preparing a crosslinked PMMA resin of claim 7, wherein the temperature during the crosslinking reaction is gradually increased.

10. The method of preparing a crosslinked PMMA resin of claim 7, wherein the PMMA resins is crosslinked with a mixture of a crosslinking agent comprising a C₂-C₅₀ linear alkyl group and a crosslinking agent comprising a C₃-C₅₀ cyclic group.

11. A transparent substrate comprising the crosslinked PMMA resin according to any one of claims 1 to 6.

12. The transparent substrate of claim 11, wherein the transparent substrate has a light transmittance of 90% or more at 550 nm.

13. The transparent substrate of claim 11, wherein the transparent substrate has a drop impact strength of 0.1-1.0 J as determined by ASTM D3763-18.

14. The transparent substrate of claim 11, wherein the transparent substrate has a pencil hardness of 3 H to 5 H.

15. A cover window for a display device comprising the transparent substrate of claim 11.

16. The cover window of claim 15, further comprising at least one of a hard coating layer and an impact-resistant layer formed on the transparent substrate of claim 11.
